(19) United States
(12) Patent Application Publication
(10) Pub. No.: US 2016/0019322 A1
(43) Pub. Date: Jan. 21, 2016

(54) Computer aided design system for pulsed extraction column operation process

(71) Applicant: China Institute of Atomic of Energy, Beijing (CN)

(72) Inventors: Yanxin Chen, Beijing (CN); Hui He, Beijing (CN); Hongbin Tang, Beijing (CN); Bin Li, Beijing (CN); Ting Yu, Beijing (CN)

(73) Assignee: China Institute of Atomic of Energy

(21) Appl. No.: 14/746,911

(22) Filed: Jun. 23, 2015

(30) Foreign Application Priority Data
Jun. 23, 2014 (CN) 201410283012.X

(51) Int. Cl. G06F 17/50; G06F 17/10

(52) U.S. Cl. CPC G06F 17/5009; G06F 17/10

(57) ABSTRACT

A computer aided design system for pulsed extraction column operation process is provided, including a data input module, a data detection module, a computing module, a computing result detection module, and an error data management module. The data input module is connected with the data detection module, the data detection module is connected with the computing module, the computing module is connected with the computing result detection module, and the error data management module is connected with the data detection module and the computing result detection module. The system of the present invention is capable of computing and displaying the concentration changes of the corresponding components during operation process in real time, and reporting abnormal conditions which may arise during operation process. After the system is running, the results themselves are stored in the storage unit, which is convenient for user's analyzing and processing operating results under different conditions.

### CROSS REFERENCE OF RELATED APPLICATION

The present invention claims priority under 35 U.S.C. 119(a-d) to CN 201410283012.X, filed Jun. 23, 2014.

### BACKGROUND OF THE PRESENT INVENTION

1. Field of Invention

The present invention relates to a computer aided design system, and more particularly to a computer aided design system for pulsed extraction column operation process.

2. Description of Related Arts

The nuclear fuel reprocessing industry is a chemical process which is involved in strong radioactivity and corrosion. Due to special industrial process, it is required for the nuclear fuel reprocessing industry to use the equipments with service life and convenient for maintenance. The pulsed extraction column has small occupied area and large processing ability, and especially, no moving parts exist in the pulsed extraction column, so that it is easy to treat the generated interfacial crud and has excellent critical size. Therefore, the pulsed extraction column becomes the commonly used extraction equipment in the nuclear fuel reprocessing industry. The pulsed extraction column is a column-type extraction equipment with energy input, the fluid in the column is able to rapidly pulsate back and forth by inputting energy, which is able to not only smash droplets, but increase the holdup fraction of the dispersed phase, thus the contact area of two phases is greatly increased and the turbulent of the phase interface is improved to promote the mass transfer process. Structurally, the pulsed extraction column comprises the pulsed packed column, the pulsed sieve plate column and the circular plate extraction column. Due to different fillers in the column body, after long-term usage, it is easy for the pulsed packed column to accumulate the interfacial crud, which leads to poor fluid flow property, product loss and other problems. Accordingly, the pulsed packed column is not adopted in the nuclear fuel reprocessing industry. Factually, the circular plate extraction column is a variant of the common pulsed sieve plate column, in which the central axis diameter of the sieve plate series is enlarged to shape the sieve plate into a circle, such that the column has more excellent critical volume which is in favor of processing the radioactive solution with high concentration. For the nuclear fuel reprocessing industry, the pulsed extraction column is factually the pulsed sieve plate extraction column, which is the equipment mainly used in the current nuclear fuel reprocessing industry at home and abroad.

However, up to now, during process operation, no computer aided system can compute and display the changes in the concentration of corresponding components in real time, report errors on abnormal working conditions which may be occurred during the process operation, and automatically store results after ending the operation to convenient for users' analyzing and processing operation results under different conditions.

### SUMMARY OF THE PRESENT INVENTION

In order to accomplish the above object, the present invention provides a computer aided design system for pulsed extraction column operation process.

The technical solution of the present invention is as follows. A computer aided design system for pulsed extraction column operation process comprises a data input module, a data detection module, a computing module, a computing result detection module, and an error data management module, wherein the data input module is connected with the data detection module, the data detection module is connected with the computing module, the computing module is connected with the computing result detection module, the error data management module is connected with the data detection module and the computing result detection module;

wherein the data input module is adapted for inputting design parameter data and process operation parameter data;

wherein the data detection module is adapted for detecting the inputted design parameter data and process operation parameter data, if an error message is detected, an error warning message is sent to the error data management module;

wherein the computing module is adapted for computing fluid hydraulic operation parameters in the pulsed extraction column, mass transfer coefficients of fluid components, an axial concentration distribution of the fluid components in an extraction segment of the pulsed extraction column and an exit concentration in aqueous phase and organic phase of the pulsed extraction column;

wherein the computing result detection module is adapted for detecting computing results of the fluid hydraulic operation parameters in the pulsed extraction column and the mass transfer coefficients of the fluid components, if an error message is detected, an error warning message is sent to the error data management module;

wherein the error data management module is adapted for warning a user to correct the inputted design parameter data and/or process operation parameter data based on whether the error warning message from the data detection module and the error warning message from the computing result detection module are accepted.

Preferably, the data input module comprises a design parameter data input unit and a process operation parameter data input unit, wherein the design parameter data input unit is adapted for inputting the design parameter data, and the process operation parameter data input unit is adapted for inputting the process operation parameter data.

Preferably, the design parameter data comprise pulsed extraction column design parameter data, pulsed extraction column operating condition parameter data and system physical property parameter data, wherein the pulsed extraction column design parameter data comprise extraction section height, extraction section diameter, sieve plate spacing, sieve plate pore size and free sectional area; the pulsed extraction column operating condition parameter data comprise pulse frequency, pulse amplitude, flow ratio, aqueous phase flow, organic phase flow and operating temperature; and the system physical property parameter data comprise mass transfer solute amount, aqueous phase density and organic phase density.

Preferably, the process operation parameter data comprise aqueous phase HNO₃ input concentration, organic phase HNO₃ input concentration, aqueous phase uranium input concentration, organic phase uranium input concentration, pulsed extraction column sieve plate segment differential amount, and a height of pulsed extraction column extraction segment axial sectional concentration monitoring point.

Preferably, the computing module comprises a first computing unit and a second computing unit, wherein the first computing unit comprises a hydraulic operation parameter computing unit and a mass transfer coefficient computing unit, the hydraulic operation parameter computing unit is adapted for computing the fluid hydraulic operation parameters in the pulsed extraction column, the mass transfer coefficient computing unit is adapted for computing the mass transfer coefficients of the fluid components in the pulsed extraction column, the second computing unit is adapted for computing the axial concentration distribution of the fluid components in the extraction segment of the pulsed extraction column and the exit concentration in aqueous phase and organic phase of the pulsed extraction column

Preferably, the fluid hydraulic operation parameters comprise dispersed phase droplet diameter, dispersed phase holdup fraction, continuous phase axial diffusion coefficient, mandatory sinking droplet microscopic speed, and free sinking droplet microscopic speed.

Preferably, the data detection module comprises a design parameter data detection unit, a computing result detection unit and a process operation parameter data detection unit;

wherein the design parameter data detection unit is adapted for detecting the inputted design parameter data, to verify whether the inputted design parameter data accord with a structural standard of the pulsed extraction column and whether the inputted design parameter data are in a hydraulic operational area, if not, an error warning message is sent to the error data management module;

wherein the computing result detection unit is adapted for detecting computing results of the fluid hydraulic operation parameter compute unit and computing results of the mass transfer coefficient compute unit, to verify whether the computing results are in a normal data range, if not, an error warning message is sent to the error data management module;

wherein the process operation parameter data detection unit is adapted for detecting the inputted process operation parameter data, to verify whether the process operation parameter data are wrong, if yes, an error warning message is sent to the error data management module.

Preferably, the system further comprises a storage module, wherein the storage module is adapted for storing computing results of the computing module, the inputted design parameter data or the corrected design parameter data, and the inputted process operation parameter data or the corrected process operation parameter data.

Preferably, the system further comprises a help module for guiding the user to reasonably input the design parameter data.

Compared with the prior art, the present invention has some beneficial effects as follows. The system provided by the present invention is capable of guiding the user to design and select parameters and timely giving the feedback of the design results and the error messages to the user, so that the basis for amending the parameters and following design is provided. After completing the structural design, hydraulic calculation and process parameter input of the pulsed extraction column in sequence, the system is capable of computing and displaying the concentration changes of the corresponding components during operation process in real time, and reporting abnormal conditions which may arise during operation process. After the system is running, the results themselves are stored in the storage unit, which is convenient for user's analyzing and processing operating results under different conditions. The present invention allows the pulsed extraction designers in the post-processing industry to be freed from the tedious chart consulting and iterative computations. At the same time, the system is also capable of reducing the amount of radioactive experimental operation operated by reprocessing factory operators, so that the operation safety of the reprocessing factory is ensured.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a computer aided design system for pulsed extraction column operation process according to a preferred embodiment of the present invention.

FIG. 2 is a flow diagram showing the working principle of the system provided by the present invention.

### DETAILED DESCRIPTION OF THE PREFERRED EMBODIMENT

The present invention is further explained in detail with the accompanying drawings.

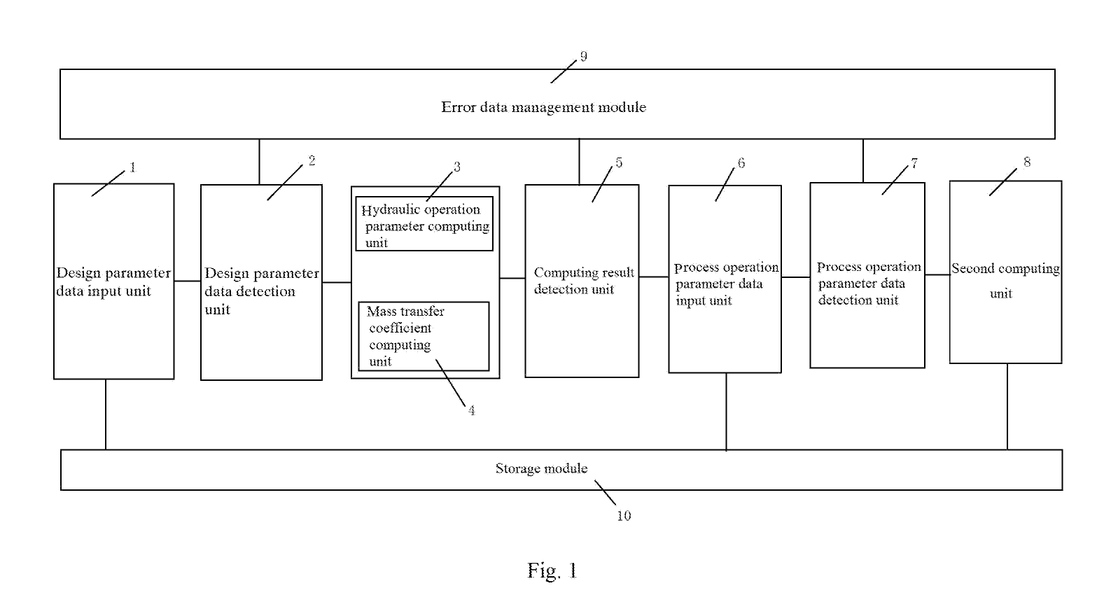

FIG. 1 shows a structural diagram of a computer aided design system for pulsed extraction column operation process provided by the present invention. The system comprises a data input module, a data detection module, a computing module, a computing result detection module, an error data management module and a storage module. The data input module is connected with the data detection module, the data detection module is connected with the computing module, the computing module is connected with the computing result detection module, the error data management module is connected with the data detection module and the computing result detection module, and the storage module is connected with the data input module and the computing module.

The data input module is adapted for inputting design parameter data and process operation parameter data; the data detection module is adapted for detecting the inputted design parameter data and process operation parameter data, if an error message is detected, an error warning message is sent to the error data management module; the computing module is adapted for computing fluid hydraulic operation parameters in the pulsed extraction column, mass transfer coefficients of fluid components, an axial concentration distribution of the fluid components in an extraction segment of the pulsed extraction column and an exit concentration in aqueous phase and organic phase of the pulsed extraction column; the computing result detection module is adapted for detecting computing results of the fluid hydraulic operation parameters in the pulsed extraction column and the mass transfer coefficients of the fluid components, if an error message is detected, an error warning message is sent to the error data management module; the error data management module is adapted for warning a user to correct the inputted design parameter data and/or process operation parameter data based on whether the error warning message from the data detection module and the error warning message from the computing result detection module are accepted; and the storage module is adapted for storing computing results of the computing module, and the inputted process operation parameter data or the corrected process operation parameter data. Furthermore, the system comprises a help module adapted for guiding the user to reasonably input the design parameter data.

The data input module comprises a design parameter data input unit 1 and a process operation parameter data input unit 6. The data detection module comprises a design parameter data detection unit 2, a computing result detection unit 5 and a process operation parameter data detection unit 7. The computing module comprises a first computing unit and a second computing unit 8, wherein the first computing unit comprises a hydraulic operation parameter computing unit 3 and a mass transfer coefficient computing unit 4. The design parameter data input unit 1 is connected with the design parameter data detection unit 2, the design parameter data detection unit 2 is connected with the first computing unit, the first computing unit is connected with the computing result detection unit 5, the computing result detection unit 5 is connected with the process operation parameter data input unit 6, the process operation parameter data input unit 6 is connected with the process operation parameter data detection unit 7, the process operation parameter data detection unit 7 is connected with the second computing unit 8, the error data management module 9 is connected with the design parameter data detection unit 2, the computing result detection unit 5 and the process operation parameter data detection unit 7, and the storage module 10 is connected with the design parameter data input unit 1, the process operation parameter data input unit 6, and the second computing unit 8.

The design parameter data input unit 1 is adapted for inputting the design parameter data, wherein the design parameter data comprise pulsed extraction column design parameter data, pulsed extraction column operating condition parameter data and system physical property parameter data, wherein the pulsed extraction column design parameter data comprise extraction section height, extraction section diameter, sieve plate spacing, sieve plate pore size and free sectional area; the pulsed extraction column operating condition parameter data comprise pulse frequency, pulse amplitude, flow ratio, aqueous phase flow, organic phase flow and operating temperature; and the system physical property parameter data comprise mass transfer solute amount, aqueous phase density and organic phase density.

The design parameter data detection unit 2 is adapted for detecting the design parameter data inputted by the design parameter data input unit 1, to verify whether the inputted design parameter data accord with a structural standard of the pulsed extraction column and whether the inputted design parameter data are in a hydraulic operational area, if not, an error warning message is sent to the error data management module 9.

The hydraulic operation parameter computing unit 3 is adapted for computing the fluid hydraulic operation parameters in the pulsed extraction column under the condition of the inputted design parameter data, wherein the fluid hydraulic operation parameters comprise dispersed phase droplet diameter, dispersed phase holdup fraction, continuous phase axial diffusion coefficient, mandatory sinking droplet microscopic speed, and free sinking droplet microscopic speed. The mass transfer coefficient computing unit 4 is adapted for computing the mass transfer coefficients of the fluid components in the pulsed extraction column under the condition of the inputted design parameter data, and in the present embodiment, the fluid components comprise nitric acid and uranium. The computing result detection unit 5 is adapted for detecting computing results of the hydraulic operation parameter computing unit 3 and computing results of the mass transfer coefficient computing unit 4, to verify whether the computing results are in a normal data range, if not, an error warning message is sent to the error data management module 9.

The process operation parameter data input unit 6 is adapted for inputting the process operation parameter data, wherein the process operation parameter data comprise aqueous phase HNO₃ input concentration, organic phase HNO₃ input concentration, aqueous phase uranium input concentration, organic phase uranium input concentration, pulsed extraction column sieve plate segment differential amount, and a height of pulsed extraction column extraction segment axial sectional concentration monitoring point. The process operation parameter data detection unit 7 is adapted for detecting the inputted process operation parameter data, to verify whether the process operation parameter data are wrong, if yes, an error warning message is sent to the error data management module 9. The second computing unit 8 is adapted for computing the axial concentration distribution of the fluid components in the extraction segment of the pulsed extraction column and the exit concentration in aqueous phase and organic phase of the pulsed extraction column

The storage module 10 is adapted for storing the computing results of the second computing unit 8, the inputted design parameter data or the corrected design parameter data, and the inputted process operation parameter data or the corrected process operation parameter data. The error data management module 9 is adapted for warning the user to correct the inputted design parameter data and process operation parameter data based on whether the error warning messages from the design parameter data detection unit 2, the computing result detection unit 5 and the process operation parameter data detection unit 7 are accepted.

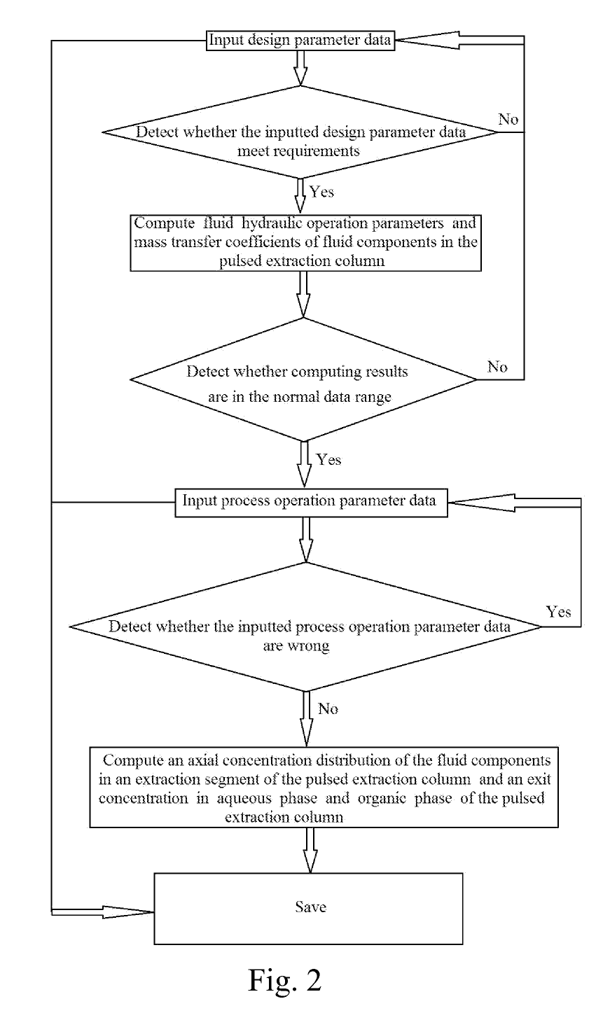

FIG. 2 is a flow diagram showing the working principle of the system provided by the present invention. Based on the user's choices or the guidance of the help module, the design parameter data are inputted to the design parameter data input unit 1, the inputted parameter data are detected by the design parameter data detection unit 2 to verify whether the inputted design parameter data meet requirements, that is to say, that whether the inputted design parameter data accord with the structural standard of the pulsed extraction column and are in the hydraulic operational area, if not, an error warning message is sent to the error data management module 9, the error data management module 9 warns the user to correct the inputted design parameter data after accepting the error warning message; if yes, the fluid hydraulic operation parameter computing unit 3 of the first computing unit computes the fluid hydraulic operation parameters in the pulsed extraction column, and the mass transfer coefficient computing unit 4 computes the mass transfer coefficients of the fluid components in the pulsed extraction column Then, the computing result detection unit 5 detects the computing results of the first computing unit, namely, the fluid hydraulic operation parameters in the pulsed extraction column and the mass transfer coefficients of the fluid components in the pulsed extraction column, for verifying whether the computing results are in the normal data range, if not, an error warning message is sent to the error data management module 9, the error data management module 9 warns the user to correct the inputted design parameter data again after accepting the error warning message; if yes, the process operation parameter data are inputted to the process operation parameter data input unit 6, the process operation parameter data detection unit 7 detects the inputted process operation parameter data, to verify whether the process operation parameter data are wrong, if yes, an error warning message is sent to the error data management module 9, the error data management module 9 warns the user to correct the inputted design parameter data after accepting the error warning message; if not, the second computing unit 8 computes the axial concentration distribution of the fluid components in the extraction segment of the pulsed extraction column and the exit concentration in aqueous phase and organic phase of the pulsed extraction column Finally, the storage module 10 stores the computing results of the second computing unit 8. Furthermore, the storage module 10 also stores the inputted design parameter data or the corrected design parameter data, and the inputted the inputted process operation parameter data or the corrected process operation parameter data, so as to convenient for user's analyzing and processing operating results under different conditions.

The system provided by the present invention is capable of guiding the user to design and select parameters and timely giving the feedback of the design results and the error messages to the user, so that the basis for amending the parameters and following design is provided. After completing the structural design, hydraulic calculation and process parameter input of the pulsed extraction column in sequence, the system is capable of computing and displaying the concentration changes of the corresponding components during operation process in real time, and reporting abnormal conditions which may arise during operation process. After the system is running, the results themselves are stored in the storage module, which is convenient for user's analyzing and processing operating results under different conditions. The present invention allows the pulsed extraction designers in the post-processing industry to be freed from the tedious chart consulting and iterative computations. At the same time, the system is also capable of reducing the amount of radioactive experimental operation operated by reprocessing factory operators, so that the operation safety of the reprocessing factory is ensured.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A computer aided design system for pulsed extraction column operation process, comprising:
a data input module, a data detection module, a computing module, a computing result detection module, and an error data management module, wherein the data input module is connected with the data detection module, the data detection module is connected with the computing module, the computing module is connected with the computing result detection module, the error data management module is connected with the data detection module and the computing result detection module;
wherein the data input module is adapted for inputting design parameter data and process operation parameter data;
wherein the data detection module is adapted for detecting the inputted design parameter data and process operation parameter data, if an error message is detected, an error warning message is sent to the error data management module;
wherein the computing module is adapted for computing fluid hydraulic operation parameters in the pulsed extraction column, mass transfer coefficients of fluid components, an axial concentration distribution of the fluid components in an extraction segment of the pulsed extraction column and an exit concentration in aqueous phase and organic phase of the pulsed extraction column;
wherein the computing result detection module is adapted for detecting computing results of the fluid hydraulic operation parameters in the pulsed extraction column and the mass transfer coefficients of the fluid components, if an error message is detected, an error warning message is sent to the error data management module;
wherein the error data management module is adapted for warning a user to correct the inputted design parameter data and/or process operation parameter data based on whether the error warning message from the data detection module and the error warning message from the computing result detection module are accepted.

2. The computer aided design system, as recited in claim 1, wherein the data input module comprises a design parameter data input unit and a process operation parameter data input unit, wherein the design parameter data input unit is adapted for inputting the design parameter data, and the process operation parameter data input unit is adapted for inputting the process operation parameter data.

3. The computer aided design system, as recited in claim 2, wherein the design parameter data comprise pulsed extraction column design parameter data, pulsed extraction column operating condition parameter data and system physical property parameter data, wherein the pulsed extraction column design parameter data comprise extraction section height, extraction section diameter, sieve plate spacing, sieve plate pore size and free sectional area; the pulsed extraction column operating condition parameter data comprise pulse frequency, pulse amplitude, flow ratio, aqueous phase flow, organic phase flow and operating temperature; and the system physical property parameter data comprise mass transfer solute amount, aqueous phase density and organic phase density.

4. The computer aided design system, as recited in claim 2, wherein the process operation parameter data comprise aqueous phase HNO₃ input concentration, organic phase HNO₃ input concentration, aqueous phase uranium input concentration, organic phase uranium input concentration, pulsed extraction column sieve plate segment differential amount, and a height of pulsed extraction column extraction segment axial sectional concentration monitoring point.

5. The computer aided design system, as recited in claim 1, wherein the computing module comprises a first computing unit and a second computing unit, wherein the first computing unit comprises a hydraulic operation parameter computing unit and a mass transfer coefficient computing unit, the hydraulic operation parameter computing unit is adapted for computing the fluid hydraulic operation parameters in the pulsed extraction column, the mass transfer coefficient computing unit is adapted for computing the mass transfer coefficients of the fluid components in the pulsed extraction column, the second computing unit is adapted for computing the axial concentration distribution of the fluid components in the extraction segment of the pulsed extraction column and the exit concentration in aqueous phase and organic phase of the pulsed extraction column.

6. The computer aided design system, as recited in claim 5, wherein the fluid hydraulic operation parameters comprise dispersed phase droplet diameter, dispersed phase holdup fraction, continuous phase axial diffusion coefficient, mandatory sinking droplet microscopic speed, and free sinking droplet microscopic speed.

7. The computer aided design system, as recited in claim 5, wherein the data detection module comprises a design parameter data detection unit, a computing result detection unit and a process operation parameter data detection unit;
wherein the design parameter data detection unit is adapted for detecting the inputted design parameter data, to verify whether the inputted design parameter data accord with a structural standard of the pulsed extraction column and whether the inputted design parameter data are in a hydraulic operational area, if not, an error warning message is sent to the error data management module;
wherein the computing result detection unit is adapted for detecting computing results of the fluid hydraulic operation parameter compute unit and computing results of the mass transfer coefficient compute unit, to verify whether the computing results are in a normal data range, if not, an error warning message is sent to the error data management module;
wherein the process operation parameter data detection unit is adapted for detecting the inputted process operation parameter data, to verify whether the process operation parameter data are wrong, if yes, an error warning message is sent to the error data management module.

8. The computer aided design system, as recited in claim 1, further comprising a storage module, wherein the storage module is adapted for storing computing results of the computing module, the inputted design parameter data or the corrected design parameter data, and the inputted process operation parameter data or the corrected process operation parameter data.

9. The computer aided design system, as recited in claim 2, further comprising a storage module, wherein the storage module is adapted for storing computing results of the computing module, the inputted design parameter data or the corrected design parameter data, and the inputted process operation parameter data or the corrected process operation parameter data.

10. The computer aided design system, as recited in claim 3, further comprising a storage module, wherein the storage module is adapted for storing computing results of the computing module, the inputted design parameter data or the corrected design parameter data, and the inputted process operation parameter data or the corrected process operation parameter data.

11. The computer aided design system, as recited in claim 4, further comprising a storage module, wherein the storage module is adapted for storing computing results of the computing module, the inputted design parameter data or the corrected design parameter data, and the inputted process operation parameter data or the corrected process operation parameter data.

12. The computer aided design system, as recited in claim 5, further comprising a storage module, wherein the storage module is adapted for storing computing results of the computing module, the inputted design parameter data or the corrected design parameter data, and the inputted process operation parameter data or the corrected process operation parameter data.

13. The computer aided design system, as recited in claim 6, further comprising a storage module, wherein the storage module is adapted for storing computing results of the computing module, the inputted design parameter data or the corrected design parameter data, and the inputted process operation parameter data or the corrected process operation parameter data.

14. The computer aided design system, as recited in claim 7, further comprising a storage module, wherein the storage module is adapted for storing computing results of the computing module, the inputted design parameter data or the corrected design parameter data, and the inputted process operation parameter data or the corrected process operation parameter data.

15. The computer aided design system, as recited in claim 8, further comprising a help module for guiding the user to reasonably input the design parameter data.

16. The computer aided design system, as recited in claim 9, further comprising a help module for guiding the user to reasonably input the design parameter data.

17. The computer aided design system, as recited in claim 10, further comprising a help module for guiding the user to reasonably input the design parameter data.

18. The computer aided design system, as recited in claim 11, further comprising a help module for guiding the user to reasonably input the design parameter data.

19. The computer aided design system, as recited in claim 12, further comprising a help module for guiding the user to reasonably input the design parameter data.

20. The computer aided design system, as recited in claim 13, further comprising a help module for guiding the user to reasonably input the design parameter data.

21. The computer aided design system, as recited in claim 14, further comprising a help module for guiding the user to reasonably input the design parameter data.
